(19) United States
(12) Patent Application Publication
(10) Pub. No.: US 2005/0031382 A1
(43) Pub. Date: Feb. 10, 2005

(54) Developer sleeve coating

(75) Inventors: Raphael McCarthy, Shenzhen City (CN); Ariel Encamado Navela, Shenzhen City (CN); An Sheng Jiang, Shenzhen City (CN); Steve Garner, Largo, FL (US); Benjamin Grundy, Shenzhen City (CN)

Correspondence Address: LINIAK, BERENATO & WHITE, LLC, 6550 ROCK SPRING DRIVE, SUITE 240, BETHESDA, MD, 20817, US

(73) Assignee: GCC Management Limited, Kowloon (HK)

(21) Appl. No.: 10/830,432

(22) Filed: Apr. 23, 2004

(30) Foreign Application Priority Data
Apr. 24, 2003 (GB) GB0309299.6

(51) Int. Cl. G03G 15/08

(52) U.S. Cl. 399/286

(57) ABSTRACT

A developer sleeve for use in a monocomponent development system has a surface coating formed by an electric arc spray method. In one embodiment compressed air at a pressure of greater than 100 psi is used for driving the metal spray from the arc to the tube to be coated. In another embodiment, the developer sleeve is fabricated using mounting components of heat capacity and thermal conductivity both higher than that of the sleeve. In a still further embodiment, compressed air at a pressure of up to 100 psi is guided into the workpiece in order to dissipate heat from the interior of the workpiece. In a yet further embodiment, compressed air is used to aid disassembly of the sleeve from a mounting system following formation of the surface coating.

This invention relates to a developer sleeve for use in a toner cartridge for an electrophotographic apparatus such as a laser printer, copier, fax or multi-function device. The function of the developer sleeve in the toner cartridge is firstly to convey toner and/or developer from a storage hopper, through a charge generating station, to a developing station where it is developed onto an image bearing member, then carrying unused developer back to the storage hopper; and secondly to enable the triboelectric charging of the developer as it passes through the charging station.

Such developer rolls or developer sleeves are known in the art both for two-component and monocomponent development systems. Typically in the art the sleeve is tubular and may be fabricated from aluminium and may contain a stationary or rotating magnet coaxial with its longitudinal axis. In any case the sleeve will rotate to perform the functions described above.

The surface of the sleeve is textured or profiled to perform its two primary functions. U.S. Pat. No. 4,377,332 describes a monocomponent system with a developer sleeve which has concavo-convexities on its surface. U.S. Pat. No. 4,380,966 describes an aluminium sleeve where the surface is roughened by sand or grit blasting with an abrasive media such as aluminium oxide.

Problems associated with developer sleeves include ghosting whereby an electrical image is stored on the sleeve throughout more than one revolution, such that a repeat image is developed several times along a page. The mechanism by which the image is stored is hypothesised in U.S. Pat. No. 4,989,044 which discloses a coating designed to better conduct charge stored on the developer sleeve surface and also to better lubricate the toner in contact with the sleeve.

Whether the sleeve is coated or uncoated, a desirable surface finish might be in the range of Ra 0.3-3.0 μm (and Rz in the range 5-30 μm) for monocomponent systems. For two-component systems on the other hand, the desirable Ra range might be 5-15 μm. In other words the average surface roughness of a sleeve designed for use in two-component systems is an order of magnitude greater than that required for monocomponent systems.

In the art there have been uncoated developer sleeves with extruded serrations (U.S. Pat. No. 5,400,124) and specially machined finishes (U.S. Pat. No. 5,483,326). There have also been different coatings which might be resin based such as U.S. Pat. No. 4,989,044 or electroplated (U.S. Pat. No. 5,781,830) or even ceramic (U.S. Pat. No. 5,563,690). Various pre- and post-coating treatments are also disclosed in the art.

Dry plating methods, defined as either physical vapour deposition or chemical vapour deposition are disclosed in U.S. Pat. No. 5,697,029 which enables a surface finish (Rz) of around 20 μm to be obtained by sputtering, making the sleeve suitable for monocomponent development. Dry plating enables the manufacturer to reduce waste to the environment, especially acids and solvents, and is therefore extremely desirable.

Metal spraying process such as electric arc spraying have been used in two-component systems but the surface finish has so far been too coarse for monocomponent development. Electric arc spraying is a desirable manufacturing process because it is dry and does not require acids or solvents. The residue is also dry and can be contained and collected. The waste is relatively inert and can be disposed of safely. Furthermore electric arc spraying does not require an inert atmosphere or vacuum.

In one aspect, the present invention relates to a method to produce a hard coating on a developer sleeve with a surface finish fine enough for monocomponent development, using an electric arc spraying method.

The use of stainless steel and copper for different applications is also disclosed.

In a still further aspect, two methods for keeping a developer sleeve cool during the coating process are provided. These reduce geometrical distortion in nylon hubs which may be preassembled into the developer sleeve prior to the electric arc spray process.

The invention will now be described by way of example with reference to the accompanying drawings in which:

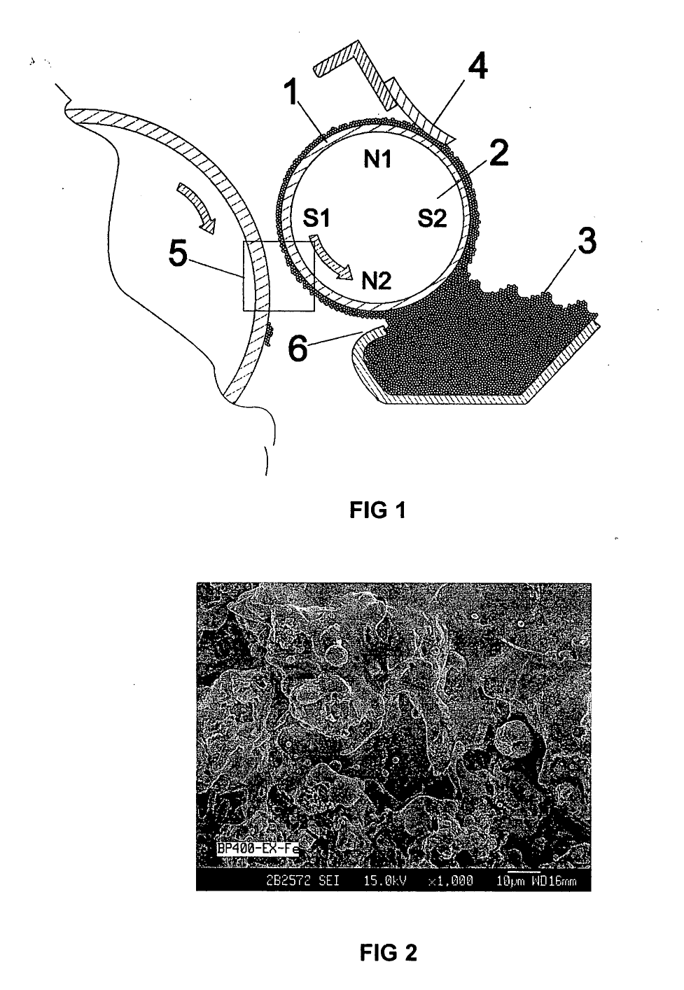

FIG. 1. Schematic cross section of a typical prior art developer roller in a monocomponent toner cartridge FIG. 2. Micrograph of the surface finish achieved using a BP400 Arc Spray System.

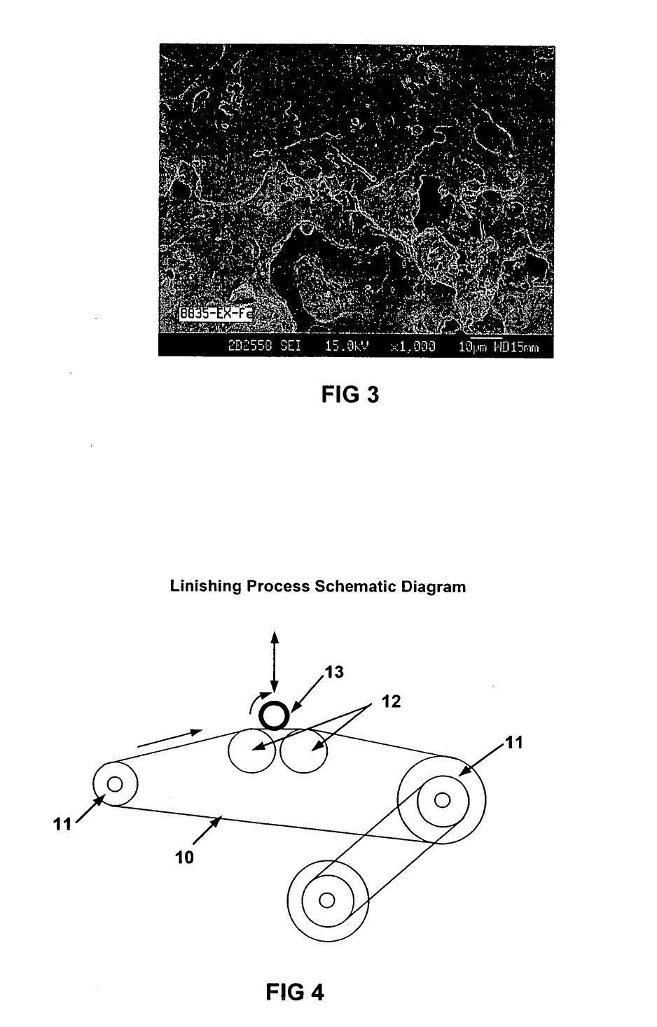

FIG. 3. Micrograph of the surface finish achieved using an 8835 Arc Jet Spray System.

FIG. 4. Schematic diagram of the linishing process used to achieve functional surface finish

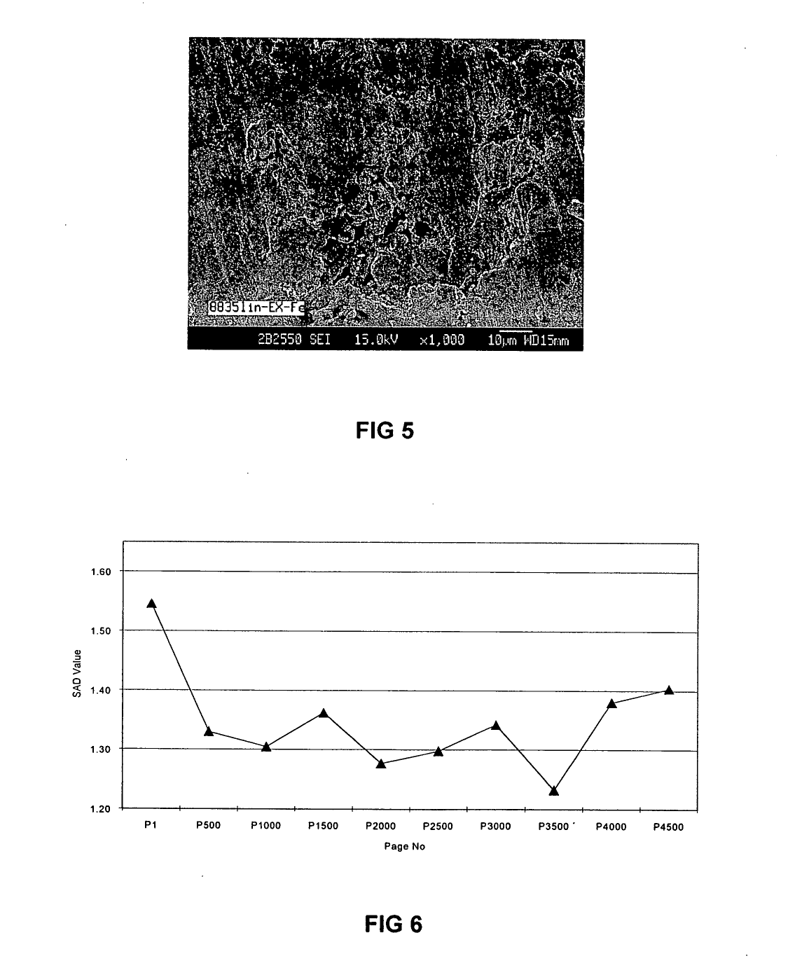

FIG. 5. Micrograph of the surface finish after linishing.

FIG. 6. Illustration of the SAD fall off over the initial 500 pages.

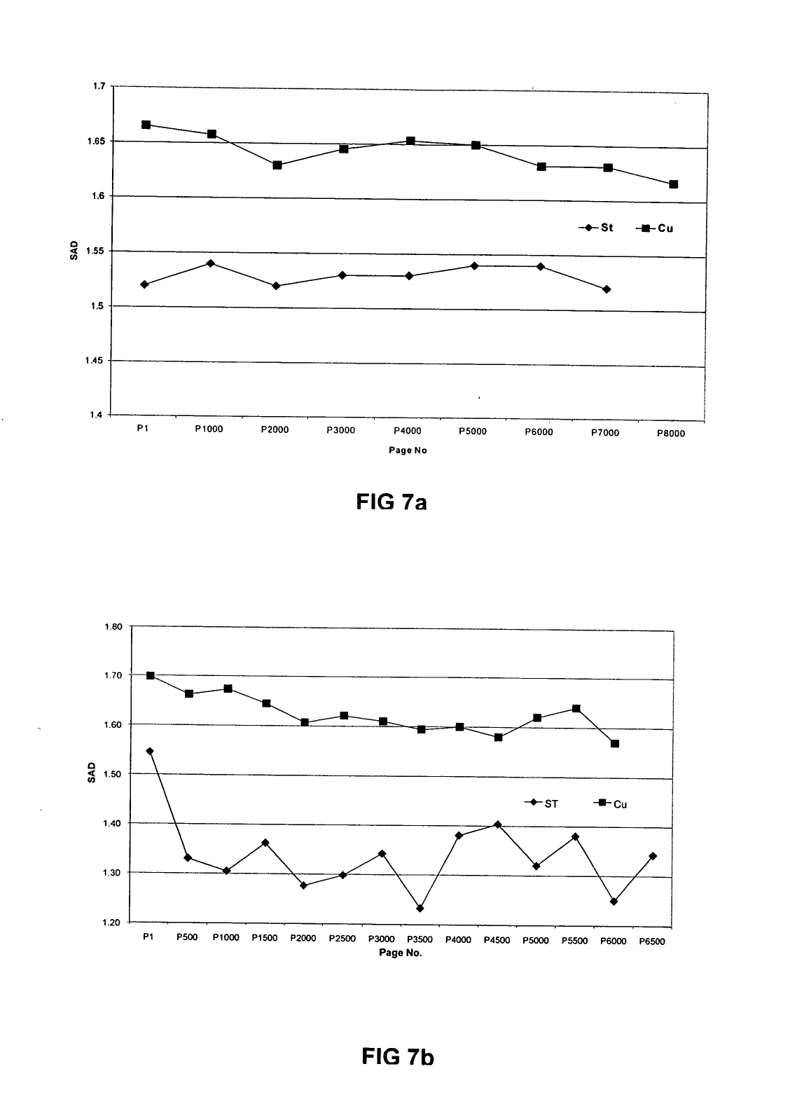

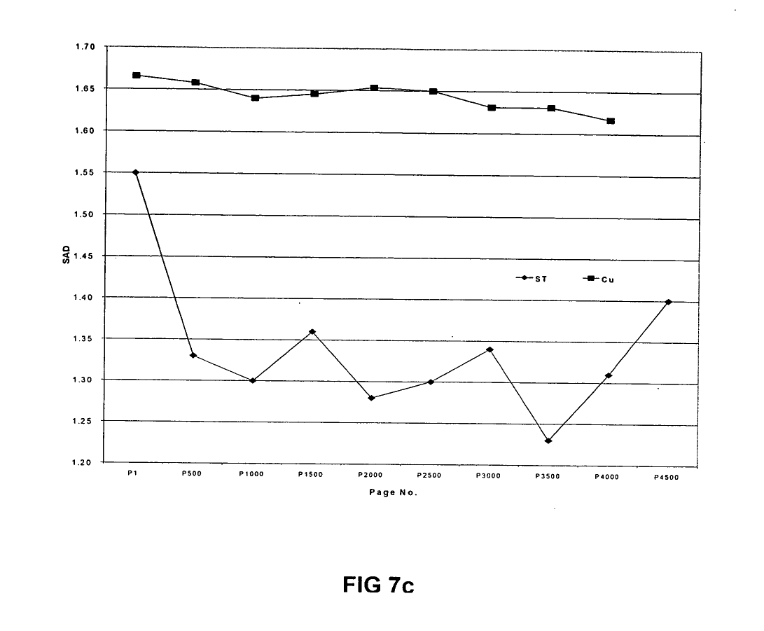

FIG. 7a. Illustration of the solid area density (SAD) versus page yield for cartridge A using both copper material and stainless steel.

FIG. 7b. Illustration of the SAD versus page yield for cartridge B using both copper material and stainless steel.

FIG. 7c. Illustration of the SAD versus page yield for cartridge C using both copper material and stainless steel.

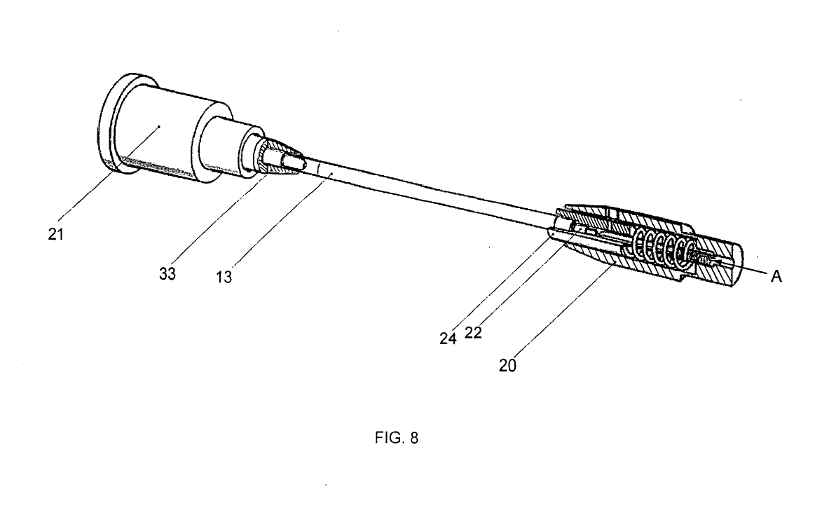

FIG. 8. Schematic diagram of the mounting system used for protecting and cooling the sleeve plastic hub during the arc spray process.

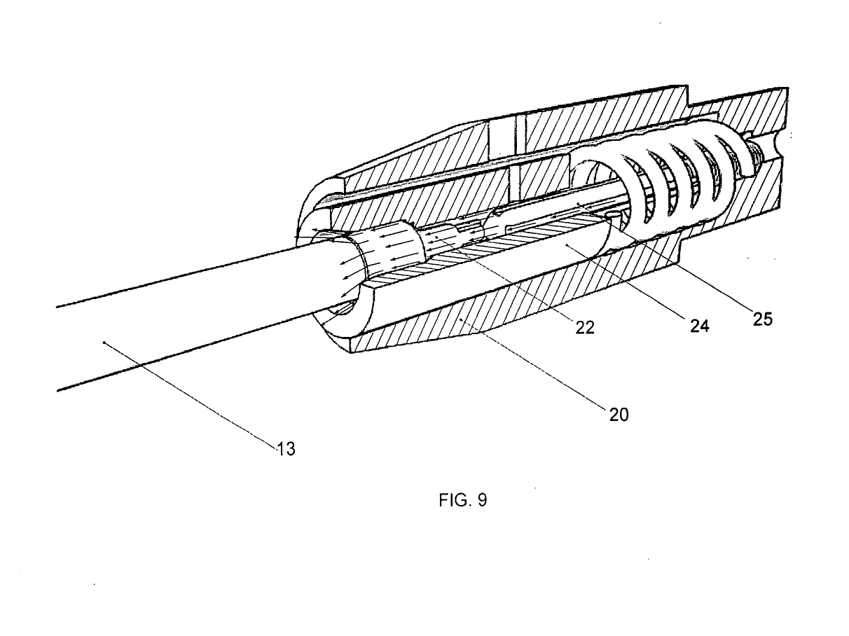

FIG. 9. Schematic diagram showing the details of air flow for cooling the sleeve plastic hub.

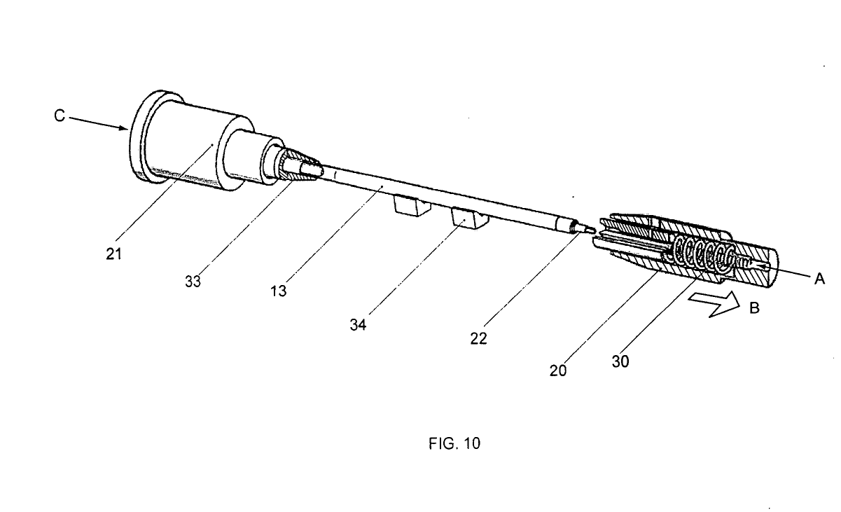

FIG. 10. Schematic diagram of the mounting system at the ejection stage after arc spray process.

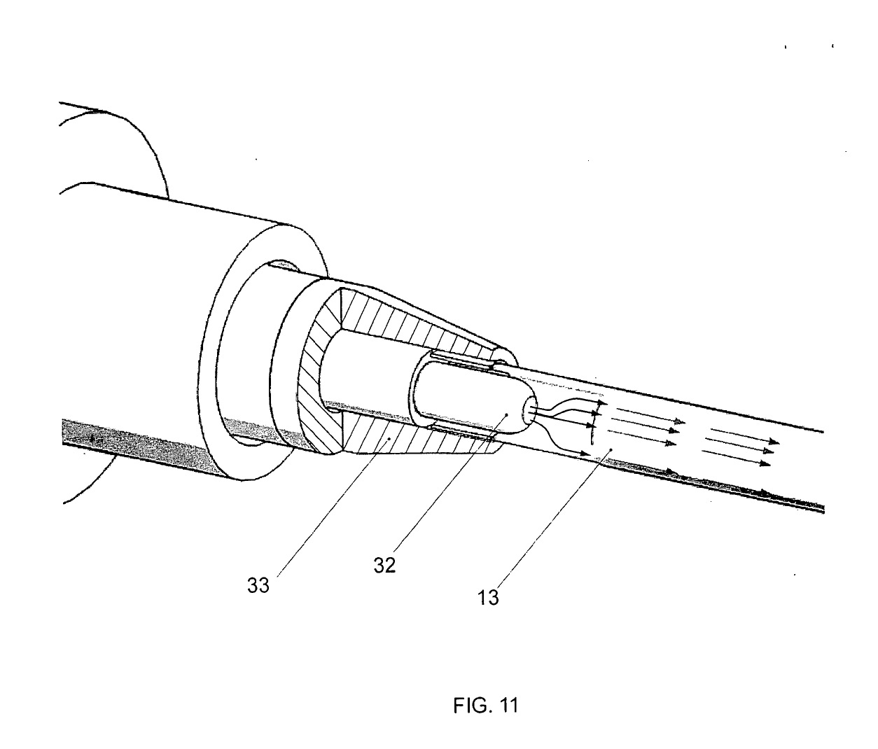

FIG. 11. Schematic diagram showing how the sleeve is ejected at the non-hub side of the mounting system.

FIG. 1 is a schematic cross section of a typical prior art developer roll designed for use in a monocomponent toner cartridge. An aluminium sleeve in tubular form (1) rotates about a stationary magnet (2) which is radially magnetised and has up to four radial poles. The sleeve is made from aluminium or some other non-magnetic material so as not to disturb the radial magnetic fields which manipulate the monocomponent developer (3) carried on the sleeve.

The sleeve is coated with a resin based material containing carbon and/or graphite and is textured to Ra 0.3-1.0 μm. As it rotates it collects developer (3) from a reservoir and drags a thin layer through a nip formed with a polyurethane blade (4). As the developer is dragged through the nip it is agitated and caused to rub against itself and also against both the polyurethane blade and the developer sleeve coating. In doing so it acquires a triboelectric charge, usually of negative polarity.

The layer of charged developer is presented to an electrophotographic member carrying a latent image at a developing station (5). In the relatively positive areas where the electrophotographic image has been exposed, the developer will transfer to the electrophotographic member and ultimately be transferred to a media such as paper (not shown). Any unused developer will be returned to the hopper via a one way valve (not shown) at position (6).

It is believed that during continuous rotations a layer of small, highly charged toner particles migrate to the developer sleeve and congregate there. The high charge to mass ratio prevents them from being developed and so they remain on the sleeve for many revolutions. This layer is then influenced by the differential electrical fields at play and store ghost images which are developed on subsequent revolutions. It is for this reason that coatings have been researched which provide a good degree of surface conductivity and surface lubricity, in order to dissipate the highly charged particles, not only of toner, but other additives as well.

Monocomponent developer basically consists of ferrite particles coated in styrene and pigmented. Such developer has become progressively finer over the last twenty years. Early laser printers had resolutions of 150 or 300 dots per inch and suitable developers had mean particle sizes of 12 μm with not more than 5% below 5 μm. Modern printers might have resolutions of 1200 dots per inch using developers of mean particle size of the order of 6 μm. Thus it can be seen that the developer sleeve is carrying a highly abrasive powder and furthermore the powder must be forced through a nip formed of polyurethane pressed onto the surface. A typical line force of the polyurethane blade might be 9 to 10 N/mm.

Using monocomponent developer in the range of size distributions indicated above, a typical charge to mass ratio might be 13 μC/gm with a range of 10 to 16 μC/gm after the developer layer has passed through the nip with the blade (4). It has been found empirically that the optimum texturing for the sleeve surface in order to convey the developer and charge it to these levels can be characterised by Ra values of 0.3-1.0 μm and Rz values of 5-30 μm.

Resin based sleeves are easier to texture (using grit blasting or the like) but are generally not hard enough to keep the texture through a great number of revolutions, due to the wearing action of the developer. On the other hand, plated or machined sleeves are comparatively hard but more difficult to texture.

An electric arc sprayed sleeve is hard and provides a texture at the same time. However the texture is in a range more suited to two component development systems, greater than Ra 10 μm for example.

For the purposes of this investigation, sleeves were fabricated using an electric arc process designed for a two component system and the resultant coated sleeves were mounted into a monocomponent system. When used in a printing environment at least two print quality defects were highlighted, namely light printing and white spots on solid black areas. It is believed that the light printing was caused by low charging which in turn is attributed to a surface finish on the developer sleeve which is too coarse. It is believed that the white spots were caused by peaks and holes in the coating which created micro short circuits and/or micro open circuits at the developing station.

A micrograph of such a surface finish is shown in FIG. 2. This surface was achieved with a BP400 electric arc spray system from Praxair Surface Technologies and using ESAB Ø16 mm stainless steel wire.

Electric arc spray is a metal deposition process where the coating material is fed as two converging wires carrying a large potential difference between them. Near the point where they would converge an electric arc is struck between them causing the wires to melt. The molten metal is then propelled onto the sleeve using compressed air.

In the case of FIG. 2, stainless steel wire was used with a potential difference of 32 volts and a current of 25 amps. The air pressure was 90 psi and the distance between the arc and the sleeve was 150 mm. The sleeve rotated at 500 rpm and the travel speed of the spray head was 3.5 m per min. The resultant surface had an Ra of 8˜10 μm and Rz 40˜60 μm.

Through formal experimentation it was determined that there was an inverse relationship between surface finish and compressed air pressure, which was more significant than the relationships of other variable parameters such as voltage, current, distance and transverse or rotational speeds.

FIG. 3 is a micrograph of a surface finish achieved using a TAFA 8835 electric arc spray system. Stainless steel wire was used with a potential difference of 28 to 32 volts and a current of 80 amps. The air pressure was 200 psi and the distance between the arc and the sleeve was 150 mm. The sleeve rotated at 1000 rpm and the travel speed of the spray head was 2.5 to 3.0 m per min. The achieved Ra was 4˜6 μm and Rz 30˜45 μm. The scale is 1000 times which is the same as FIG. 2. As can be seen the surface appears to be more contiguous. Using this finish in the same monocomponent system as above, the print quality was much improved but still showed white spots.

The improvement in the performance of the sleeves when sprayed with the TAFA 8835, over those sprayed by the BP400 system was attributed by the inventors to the increase in compressed air pressure used to drive the spray and in particular the increase beyond 100 psi.

The advantage of increased air pressure is the effect upon the surface morphology of the coated sleeve. However another advantage is that the process is cooler and as shall be explained, this reduces the possibility of deformation of any plastic hub inserted at one end of the developer sleeve.

In order to further improve the surface finish a linishing operation was added. As shown in FIG. 4 a linishing belt (10) is caused to move along an endless path defined by guide rollers (11) and support rollers (12). A developer sleeve (13) with an electric arc sprayed coating is supported on a pneumatic arm and rotated in the opposite direction to the surface movement of the linishing belt.

In this embodiment the belt (10) is a 3M 372L aluminium oxide linishing belt with an 80 m finish and total length of approximately 1500 mm. It is caused to rotate at 7000 rpm in a direction shown in FIG. 4 as clockwise. The developer sleeve (13)is caused to rotate in a clockwise direction at 850 rpm and the sleeve is held in contact with the belt for approximately 5 seconds.

The resultant surface morphology is shown to the same scale in the FIG. 5 micrograph. This finish has an Ra of 2˜5 um and an Rz of 16 μm˜21 μm. In the same monocomponent system as above, this sleeve gave a high quality print which displayed the following characteristics:

| | |
|---|---|
| Solid Area Density | 1.53 |
| Uniformity | 0.06 |
| Background | 0.07 |

The toner used had a mean particle size of 9 μm and using the sleeve with the surface finish shown in FIG. 5 attained an average charge to mass ratio of 13 μC/gm.

As a control, a resin sleeve which had previously been specified with the development system used in this experiment was substituted back into the system and the print quality was shown to be marginally inferior using the resin based sleeve:

| | |
|---|---|
| Solid Area Density | 1.46 |
| Uniformity | 0.13 |
| Background | 0.07 |

The average charge to mass ratio was measured at 7 μC/gm.

It was found that grinding the sprayed surface could also produce an effective surface finish. In fact the ground surface had a better uniformity than an equivalent linished surface but overall the triboelectric properties of the linished surface were found to more closely match the requirements of the cartridge systems under development.

However a common drawback of monocomponent systems is a reduction in solid area density which occurs after a specific number of prints during the life of a toner cartridge. Typically a toner cartridge might be designed to provide 4,000 prints at an average black coverage of 5% of the printed page. The initial solid area density (SAD) might be 1.50 units on a MacBeth Densiometer but during the initial 500 prints there is a sharp decline in SAD. A typical graph is shown in FIG. 6.

Possible causes for the sharp inflection could be (a) preferential toner selection whereby the toner with the most ideal development properties is used up first; and/or (b) a result of the boundary layer formation as a result of the segregation of particle sizes towards and away from the surface as described above.

Empirically three cartridges having different size and speed parameters, but essentially the same xerographic configuration were investigated.

| Parameter | Units | Cartridge A | Cartridge B | Cartridge C |
|---|---|---|---|---|
| Photoreceptor Diameter | mm | 30 | 24 | 24 |
| Photoreceptor Surface Speed | mm/sec | 4239 | 3014 | 3014 |
| Developer Sleeve Diameter | mm | 16 | 12 | 12 |
| Developer Sleeve Surface Speed | mm/sec | 4239 | 3014 | 3014 |
| Tribo Blade Line Force | N/mm | 9.90 | 10.10 | 9.708 |
| Magnet Developer Pole Radial Field | G | | | |
| N1 | G | 850 | 700 | 800 |
| N2 | G | 750 | 600 | 770 |
| S1 | G | 950 | 750 | 820 |
| S2 | G | 770 | 660 | 770 |
| Toner Mean Particle Size | μm | 9 | 9 | 9 |
| Toner Charge Capacity (blow-off method) | μC/gm | 21 | 21 | 21 |
| Development Gap | mm | 0.35 | 0.40 | 0.28 |
| Printer Type | | HP LJ-4plus | HP LJ-6P | HP LJ-6L |

The Printers in the above table are manufactured by Hewlett Packard (HP) and branded under the name Laserjet (LJ).

Two wire media were trialled to create surfaces on developer sleeves: stainless steel and copper. The target SAD was 1.4 to be maintained through life.

The arc spray equipment settings for copper and steel media were set as follows:

| Material | Air Pressure | Cross Speed | Rotation Speed | Arc Current | Voltage |
|---|---|---|---|---|---|
| Stainless Steel | 200 psi | 2.5˜3.0 m/min | 1000 rpm | 80 amps | 30 ± 2 V |
| Pure Copper | 200 psi | 3.0˜3.5 m/min | 1000 rpm | 80 amps | 30 ± 2 V |

The steel surface in this experiment had an Ra of 2 μm˜5 μm and Rz of 16 μm to 21 μm. The copper finish had an Ra 2 μm˜5.0 μm and Rz 16 μm˜22 μm. When trialled with cartridges A, B and C the SAD results against the 1.4 specification can be summarised as:

| | Steel | Copper |
|---|---|---|
| Cartridge A | Good | Good |
| Cartridge B | Marginal | Good |
| Cartridge C | Below Spec | Good |

FIGS. 7a, 7b and 7c show graphically the SAD against number of pages printed through the lives of Cartridges A, B and C respectively.

From these results it can be concluded that copper is the better material to use in a monocomponent cartridge system and that this becomes more critical as the surface speeds of the photoreceptor and developer roll decrease.

Developer sleeves for use in monocomponent toner cartridges are frequently installed with a hub at at least one end. The hub can serve to locate the magnet within the sleeve and also to mount the sleeve in a process cartridge and transmit rotational drive to the sleeve. The hub can be of a similar or different material to the tube itself and can be fitted in a variety of different ways including crimping, press fit and gluing. A cost effective solution is to mould at least one hub out of a polymer such as nylon and to crimp it into place at one end of the sleeve.

Although only for a short time, during the arc spray process, the temperature of the workpiece (in this case an assembled developer sleeve with one plastic hub) reaches 100˜150° C. This temperature is sufficient to at least distort the nylon hub. This is critical when the device relies on correct installation of the hub to maintain the correct geometry of the xerographic system.

In order to dissipate the workpiece heat as quickly as possible, the chucks to hold the workpiece can be fabricated out of copper and made relatively massive in order to absorb the heat according to the principles of conduction and specific thermal capacity. A second measure is to blow compressed air through the workpiece in order to provide a forced convection. In the case of sleeves fabricated for use in the above experiments, compressed air at 75 psi and 25° C. was forced through the centre of the sleeves.

Thirdly the use of an electric arc spray system using compressed air at higher pressures than 100 psi to drive the spray has a beneficial effect of cooling the process. Empirically it has been found that a developer sleeve having a nylon moulded hub at one end will deform in a low pressure system when the arc current exceeds 25 amperes. However in a high pressure system (200 psi spray pressure) the same deformation will not occur unless the arc current exceeds 85 amperes.

FIG. 8 shows a cut-away perspective of the mounting system used for a developer sleeve (13) having a nylon hub (22) at the right hand end, also shown in FIG. 9 which is an enlarged view of the end containing the hub. Returning to FIG. 8 the sleeve (13) is mounted between two holders (20) and (21) with rotational drive provided at (21). The sleeve is sheathed by two copper covers (24) and (33) which mask the areas which are designed to be free of coating and also to conduct away waste heat. However in addition to conduction by the covers (24) and (33) air is introduced in direction A to further cool the nylon hub by convection.

Referring to FIG. 9 it can be seen that the air flows around a locator spindle (25) and flows through and around the hub in the direction shown by the arrows.

FIG. 10 illustrates the unloading mechanism after completion of the arc spray process. While air is still being blown through the mounting assembly in direction A, the assembly is withdrawn in direction B. The sleeve is ejected by spring (30) and remains supported by pneumatically driven supports (34).

At the opposite (non-hub) end the disassembly is aided by air driven in direction C through an air ejector tube (32) as shown in FIG. 11.

Employing the two measures of copper collets and forced convection it was found that the structural integrity of a nylon hub could be preserved.

1. A method for fabricating a developer sleeve for use in a monocomponent development system comprising forming a surface coating by electric arc spraying, characterised by the use of compressed air at a pressure greater than 100 psi for driving the metal spray from the arc to the tube to be coated.

2. A method according to claim 1 where the sprayed surface is further processed to reduce the surface roughness of the sprayed sleeve.

3. A method according to claim 2 where the further process is linishing.

4. A method according to claim 2 the further process is grinding.

5. A method according to claim 1 where the metal media is a stainless steel alloy.

6. A method according to claim 1 where the metal media is pure copper or a copper alloy.

7. A method for fabricating a developer sleeve for use in a monocomponent development system, having a surface coating formed by an electric arc spray method, characterised by the use of compressed air for driving the metal spray from the arc to the tube to be coated, and by the use of mounting components of heat capacity and thermal conductivity both higher than that of the sleeve.

8. A method for fabricating a developer sleeve according to claim 7 where the mounting components are fabricated from copper or a copper alloy.

9. A method for fabricating a developer sleeve characterised by the use of compressed air at a pressure of up to 100 psi being guided into the workpiece in order to dissipate heat from the interior of the workpiece.

10. A method according to claim 9 wherein the sleeve is for use in a monocomponent development system and has a surface coating formed by an electric arc spray method.

11. A method for fabricating a developer sleeve, characterised by the use of both conductive and convective cooling means to dissipate heat from the workpiece.

12. A method according to claim 11 wherein the sleeve is for use in a monocomponent development system and has a surface coating formed by an electric arc spray method.

13. A method for removing a developer sleeve following formation of a surface coating characterised by the use of compressed air to aid the disassembly of the sleeve from a mounting system.

14. A method according to claim 13 where the compressed air is also used to cool the workpiece both before and during disassembly.

15. A method according to claim 13 wherein the sleeve is for use in a monocomponent development system and has a surface coating formed by an electric arc spray method.

16. A developer sleeve for use in a monocomponent development system, having a surface coating formed by an electric arc spray method, characterised by the use of compressed air at a pressure greater than 100 psi for driving the metal spray from the arc to the tube to be coated.

17. A developer sleeve according to claim 16 where the sprayed surface is further processed to reduce the surface roughness of the sprayed sleeve.

18. A developer sleeve according to claim 17 where the further process is linishing.

19. A developer sleeve according to claim 17 where the further process is grinding.

20. A developer sleeve according to claim 16 where the metal media is a stainless steel alloy.

21. A developer sleeve according to claim 16 where the metal media is pure copper or a copper alloy.

22. A developer sleeve for use in a monocomponent development system, having a surface coating formed by an electric arc spray method followed by a linishing method, characterised by a resultant surface finish of Ra in the range 2 μm to 5 μm.

23. A developer sleeve for use in a monocomponent development system, having a surface coating formed by an electric arc spray method followed by a linishing method, characterised by a resultant surface finish of Rz (ten point mean amplitude) in the range 14 μm to 22 μm.
